(19) United States
(12) Patent Application Publication
(10) Pub. No.: US 2003/0097243 A1
(43) Pub. Date: May 22, 2003

(54) Method and system for operating a hydrocarbon production facility

(76) Inventors: Thomas Gilmore Mays, Houston, TX (US); Joseph McClintock Kunkel III, Kingwood, TX (US)

Correspondence Address: FINA TECHNOLOGY INC, PO BOX 674412, HOUSTON, TX, 77267-4412, US

(21) Appl. No.: 10/278,668

(22) Filed: Oct. 23, 2002

Related U.S. Application Data
(60) Provisional application No. 60/345,367, filed on Oct. 23, 2001.

(51) Int. Cl. G06F 17/10

(52) U.S. Cl. 703/2

(57) ABSTRACT

A computerized system and method for operating a hydrocarbon or chemical production facility, comprising mathematically modeling the facility; optimizing the mathematic model with a combination of linear and non-linear solvers; and generating one or more product recipes based upon the optimized solution. In an embodiment, mathematic model further comprises a plurality of process equations having process variables and corresponding coefficients, and preferably wherein the process variables and corresponding coefficients are used to create a matrix in a linear program. The linear program may be executed via recursion or distributed recursion. Upon successive recursion passes, updated values for a portion of the process variables and corresponding coefficients are calculated by the linear solver and by a non-linear solver, and the updated values the process variables and corresponding coefficients are substituted into the matrix.

### CROSS-REFERENCE TO RELATED APPLICATIONS

The present application claims benefit of priority from U.S. Application Serial No. 60/345,367, filed Oct. 23, 2001, entitled “Integrating Third Party Simulators Via PIMS-SI”.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to a method and system for the operation of a hydrocarbon production facility. More particularly, the invention relates to the method and system for optimizing the operation of a hydrocarbon production facility using a computerized process simulator comprising a linear solver and non-linear solver system.

### BACKGROUND OF THE INVENTION

Hydrocarbon production facilities typically consist of a plurality of integrated, controlled chemical and/or refining processes for producing desired products such as gasoline, diesel, and asphalt. Difficulties arise in effectively controlling and optimizing such an integrated process due to the large number of process variables such as feedstock compositions; the wide variety of processing units and equipment; operating variables such as processing rates, temperatures, pressures, etc.; product specifications; market constraints such as utility and product pricing; mechanical constraints; transportation or storage constraints; weather conditions; and the like. For example, the feedstock composition, such as the sulfur content of crude oil being fed to a petroleum refinery, may change from one pipeline or tanker supply to the next. Given that the amount of sulfur in refined products is often limited, variation in sulfur content of the crude feed can lead to difficulties in producing and blending suitable products such as low sulfur diesel while maximizing overall profitability of the integrated process. Therefore, control and optimization of the refinery process is important for producing the desired products and for maximum profitability.

Control of the refining process is typically achieved through known process control parameters such as mass and energy balances implemented by complex process operation and control technology that is often highly automated and computerized. However, the control settings frequently are not optimized to produce the desired products while maintaining maximum profitability. As a result, various optimization techniques and schemes have been applied to hydrocarbon production processes. In general, optimization is achieved through computer simulation by first mathematically modeling or simulating a given process based upon known relationships and constraints such as mass and energy balances, system kinetics, etc., and subsequently solving the mathematical model to achieve an optimization of one or more desired variables, typically to maximize profitability of the process. Given the large number of process variables as described previously, such mathematical models may be very large and complex.

Process models typically can be divided into two categories, both adhering to the principles of scientific method, which include observation and description of a phenomenon or group of phenomena; formulation of an hypothesis to explain the phenomena; use of the hypothesis to predict the existence of other phenomena, or to predict quantitatively the results of new observations; and performance of experimental tests of the predictions by several independent experimenters and properly performed experiments. The first category is statistical based models such as those employing multiple regressions of data (multiple variables). When fitting data to a curve (function), regression is a technique to minimize the error between the actual data versus the data along the predicted curve via changing the coefficients, e.g., the slopes and intercepts for the curve called a line. Recursion, discussed below, is similar but for a system of equations, not just a single equation. The second category is first principle based models such as those employing accepted laws and theories regarding chemical thermodynamics and/or kinetics.

Statistical models may be defined as any mathematical relationship (functions) or logic (if-then statements) developed using accepted statistical methods on a data set, which represents an actual process. In general, statistical models tend to be more resource intensive because they are based on actual data gathered from the process. For example, a statistical model might be based on process test-runs or experimental design data, which can be both manpower intensive and laboratory intensive to gather as such typically are not automated. Alternatively, a statistical model might be based on day to day operational yield of the process, which might be automated and use budgeted routine lab samples as a data source, but would still require statistical analysis.

First principle models may be defined as any mathematical relationship or logic utilizing accepted scientific theories or laws (relationships and logic), whereby these theories and laws have already been validated through repeated experimental tests. While first principle models typically have less variance than statistical models, first principle models still must be tuned, as shown by the following simplified equation:

Dependent Variables=A*(First Principle Model)+B,

where, in order to correct systematic errors, A and B are coefficients that are adjusted such that the model is tuned to more closely approximate current operating conditions.

Once the category of model is selected (i.e., statistical or first principle) and developed based upon the numerous variables associated with the given process to be modeled, a method for solving the model (sometimes referred to as a solver or optimizer) must be employed to achieve the desired objectives. As noted previously, the obvious and most common business objective is to maximize profitability. However, more than one objective may be present, for example meeting regulatory requirements for operation of the process or customer product specifications, and such objectives may be referred to as constraints upon the model. Also, engineering restrictions exist based on the engineering design criteria of process equipment and the like. Thus, where multiple business objectives or engineering restrictions exist, such objectives typically become constraints on the primary objective of maximizing profitability. As for solving the model to maximize profitability given existing constraints, numerous options are available as shown in FIG. 1, which is known as the NEOS Guide Optimization Tree (reference numeral 200) made available on the world wide web by the Department of Energy—Argonne National Lab and Northwestern University. As can be seen from FIG. 1, mathematical solvers can be categorized as discrete 210 or continuous 220, with the continuous solvers being further sub-categorized as unconstrained 225 or constrained 230. Given the presence of constraints as discussed above, typical solvers employed for use in process simulators are continuous, constrained solvers, for example solvers known as constrained linear programs 235 or constrained non-linear programs 240.

A linear program addresses the problem of minimizing or maximizing a linear function (with respect to a vector) subject to a nonzero finite number of linear equations and linear inequalities (with respect to the same vector). That is, a linear program (LP) is a problem that can be expressed as follows (the so-called standard form):

minimize cx

subject to Ax=b

x>=0

where x is the vector of variables to be solved for, A is a matrix of known coefficients, and c and b are vectors of known coefficients. The expression cx is called the objective function, and the equations Ax=b are called the constraints. All these entities must have consistent dimensions, of course, and symbols may be transposed as desired. The matrix A is generally not square, hence an LP is not solved by simply inverting A. Usually, A has more columns than rows, and Ax=b is therefore quite likely to be under-determined, leaving great latitude in the choice of x with which to minimize cx. Also, linear programs can handle maximization problems just as easily as minimization (in effect, the vector c is just multiplied by −1).

A nonlinear program (NLP) is a problem that can be put into the form:

minimize F(x)

subject to gi(x)=0 for i=1, . . . , ml where m1>=0

hj(x)>=0 for j=m1+1, . . . , m where m>=m1

That is, there is one scalar-valued function F, of several variables (x here is a vector), that is to be minimized, subject (perhaps) to one or more other such functions that serve to limit or define the values of these variables. F is called the objective function, while the various other functions are called the constraints. Maximization may be achieved by multiplying F by −1.

As would be expected, error can occur where a linear solver is used to solve a model wherein the process being modeled displays non-linear behavior. Furthermore, a large amount of time may be required for a non-linear solver to converge upon a solution for the model, especially where the initial values or guesses for the process variables contained in the model are far away from the actual converged solution values, thus requiring numerous iterations or recursion passes to reach a solution. The present invention addresses the need for a process and system for optimizing the operation of a hydrocarbon production facility by accurately simulating both linear and non-linear process behavior while quickly converging upon a solution.

### SUMMARY OF THE INVENTION

The present invention provides a method for operating a hydrocarbon or chemical production facility, comprising mathematically modeling the facility; optimizing the mathematic model with a combination of linear and non-linear solvers; and generating one or more product recipes based upon the optimized solution. In an embodiment, mathematic model further comprises a plurality of process equations having process variables and corresponding coefficients, and preferably wherein the process variables and corresponding coefficients are used to create a matrix in a linear program. The linear program may be executed via recursion or distributed recursion. Upon successive recursion passes, updated values for a portion of the process variables and corresponding coefficients are calculated by the linear solver and by a non-linear solver, and the updated values the process variables and corresponding coefficients are substituted into the matrix. The recursion continues until the updated values for the process variables and corresponding coefficients calculated by the linear program for the current recursion pass are within a given tolerance when compared to their corresponding values for the immediately preceding recursion pass. In an embodiment, the production facility is a petroleum refinery or a unit thereof such crude distillation, hydrocarbon distillation, reforming, aromatics extraction, toluene disproportionation, solvent deasphalting, fluidized catalyst cracking (FCC), gas oil hydrotreating, distillate hydrotreating, isomerization, sulfuric acid alkylation, and cogeneration is simulated by the non-linear solver. In an embodiment, the generated recipes are for one or more products selected from the group consisting of hydrogen, fuel gas, propane, propylene, butane, butylenes, pentane, gasoline, reformulated gasoline, kerosene, aviation fuel, high sulfur diesel, low sulfur diesel, high sulfur gas oil, low sulfur gas oil, and asphalt.

The present invention further provides a computerized system for operating a hydrocarbon or chemical production facility, comprising a computer hosting a mathematic model of the facility, wherein the computer optimizes the mathematic model by executing a combination of linear and non-linear solvers and generates one or more product recipes based upon the optimized solution. In an embodiment, the computer interfaces with process controllers within the production facility to provide set points based upon the optimized solution. In another embodiment, the computer controls a product blending system within a petroleum refinery to produce one or more products selected from the group consisting of hydrogen, fuel gas, propane, propylene, butane, butylenes, pentane, gasoline, reformulated gasoline, kerosene, aviation fuel, high sulfur diesel, low sulfur diesel, high sulfur gas oil, low sulfur gas oil, and asphalt.

### BRIEF DESCRIPTION OF THE DRAWINGS

For a more detailed description of the preferred embodiment of the present invention, reference will now be made to the accompanying drawings, wherein:

FIG. 1 is the NEOS Guide Optimization Tree;

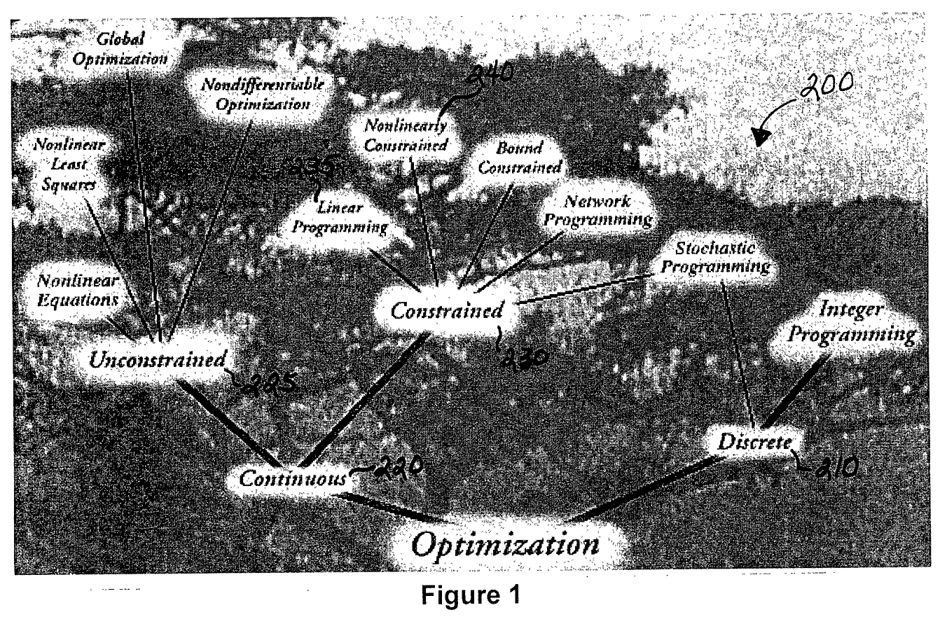

FIG. 2 is a diagram of a process to be optimized according to the present invention; and

FIG. 3 is a flow chart showing an embodiment of the present invention for producing product recipes.

### DETAILED DESCRIPTION OF THE PREFERRED EMBODIMENTS

The present invention is applicable to any hydrocarbon production facility such as a petroleum refinery, chemical plant, and the like. A facility or plant model (sometimes referred to as a simulator) is prepared on a computing system to represent the overall process to be optimized, and such a model may comprise any number of suitable programming layers or model components (often corresponding to separate processing units within the production process) operatively coupled to one another for communication, such as site-models, sub-models, and the like. Process engineers are typically involved in preparing such models to accurately simulate the real-world performance of the production facility. Model components preferably comprise computer programs or applications that are operatively coupled by object oriented programming means and techniques, such as events, methods, calls, and the like. Suitable computer languages for implementation of the present invention include C++, C#, Java, Visual Basic, Visual Basic for Applications (VBA), Net, Fortran, and the like. Suitable object oriented technology includes object linking and embedding (OLE), component object models (COM, COM+, DLLs), active X data objects (ADO), data access objects (DAO), meta language (XML), and the like. Suitable computing platforms for hosting the present invention include Windows XP, OSX, and the like.

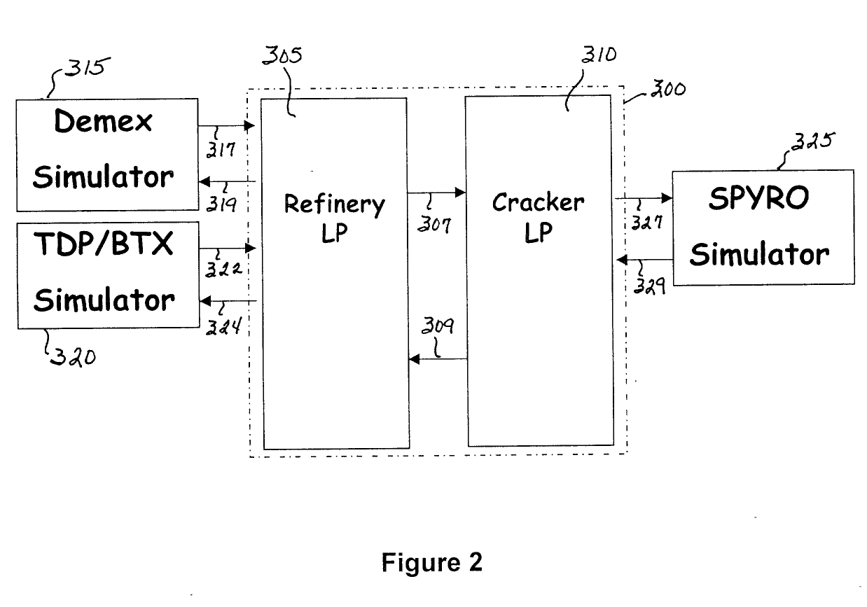

FIG. 2 is a block diagram of a model of a hydrocarbon production facility, which is Atofina Petrochemical, Inc.'s Port Arthur Refinery located on the Texas Gulf Coast. A hydrocarbon production facility typically comprises a plurality of separate processing units integrated into an overall production facility. The multi-plant model 300 comprises a number of operatively coupled sub-models, which are used to model specific process units within the refinery. The multi-plant model 300 comprises a refinery site model 305 and steam cracker site model 310 operatively coupled to each other for communication, such as data exchange, as shown by arrows 307 and 309. The refinery site model 305 is used to model typical refinery process units, such as a crude unit, reforming, aromatics extraction, solvent deasphalting, fluidized catalyst cracking (FCC), gas oil hydrotreating, distillate hydrotreating, isomerization, sulfuric acid alkylation, cogeneration, and the like. The steam cracker site model 310 is used to model a process for the steam cracking of naphtha to produce feedstocks for ethylene and propylene production. Site models 305 and 310 are preferably linear programs and, more preferably, are linear programs built using a process industry modeling systems (PIMS), for example Aspen PIMS™ Linear Program model, commercially available from Aspen Technology Inc. or GRTMPS available from Haverly Systems, Inc., each of which collectively referred to herein as PIMS-LP. The PIMS-LP employs an underlying linear solver, either CPLEX® or XPRESS®), provides recursion and distributive recursion functionality or the like (non-linear functionality), and allows access by the user to the underlying linear program matrix via a simulator interface (SI) known as PIMS-SI after at least one pass through the linear solver.

The site models may further comprise operatively coupled sub-models related to specific units such as those identified previously, and such sub-models may be of any suitable category (i.e., first principal or statistical) and employ any suitable solver (e.g., linear, non-linear, etc.). For example, refinery site model 305 further comprises UOP DEMEX Process Unit (demetalization extractor unit, also referred to as solvent deasphalting, for asphalt production) simulator 315 operatively coupled to the refinery LP for communication as shown by arrows 317 and 319 and TDP-BTX (toluene disproportionation reactor and benzene, toluene, and xylene fractionation) simulator 320 operatively coupled to the refinery LP for communication as shown by arrows 322 and 324. UOP DEMEX Process Unit simulator 315 is preferably a statistical, multi-regression model employing a non-linear type solver, preferably implemented using a spreadsheet such as EXCEL available from Microsoft Corporation, and preferably based upon test-run data obtained from a UOP DEMEX Process Unit. TDP-BTX simulator 320 is preferably a first principle model employing a non-linear solver, and more preferably is PRO/II® available from SimSci. Steam cracker sub-model 310 further comprises steam cracker heaters simulator 325 operatively coupled to the steam cracker LP for communication as shown by arrows 327 and 329, which preferably is a first principle, non-linear model known as SPYRO® that is commercially available from Technip-Coflexip. While not shown in FIG. 2, additional sub-models may be employed for units such as the FCC, reformer, and gas oil hydrotreater, preferably simulators known as Profimatics available from KBC Advance Technology, HYSYS available from Hyprotech, or other suitable commercially available simulator.

An embodiment of the present invention comprises a three layer system wherein non-linear model components are used to model behavior at the unit level (i.e., optimize unit level and product blending operations), linear model components are used to model behavior at the plant level (i.e., optimize plant level operations), and the linear models being further linked to model the overlap in behavior between plants at the facility level (i.e., overall optimization for the integrated production process for the multi-plant facility). To find an accurate solution for maximizing profit subjected to constraints within a timely fashion, benefits have been found to combine LP with NLP methods as described herein, thereby allowing the user to obtain both timeliness and accuracy at the same time. An LP typically is able to quickly describe the cost and routing of the material (overall overlap), but has a difficult time describing localized unit process operations (localized interactions). A NLP typically is able to more accurately reflect the processes but at the cost of speed.

Recursion and Distributive Recursion (DR) techniques have been developed to join different optimization methods for improving inaccurate data in the model as it is being solved. Recursion is a process of solving a model, examining the optimum solution using an external program, calculating physical property data, updating the model using the calculated data, and solving the model again. This process is repeated until the changes in the calculated data are within specified tolerances. In simple recursion, the difference between the user's guess and the optimum solved value calculated in an external computer program, updated, and re-optimized.

A distributive recursion (DR) model structure moves the error calculation from outside the LP solution to inside the LP matrix itself, which provides error visibility for linked upstream and downstream process variables. After the current matrix is solved using initial physical property estimates or guesses, new values are computed from the solution and inserted into the matrix for another LP solution. The major distinction between DR and simple recursion is the handling of the difference between the guess and the interim solution, called “error.” When the user guesses at the physical properties of recursed pools in an LP model, error is created because the user typically guesses incorrectly. However, in a DR recursion model, an upstream producer of a material is aware of the requirements of a downstream producer and visa versa. This allows the DR model to economically balance the cost of production with a more complete picture of the entire facility or process being modeled.

As described previously, one or a combination of optimization techniques may be used to find the maximum benefit of converting crude oil to refined products or chemical feedstocks to chemical products. However, it has been found that using the combination of both LP and NLP optimization techniques has the benefits of producing a recipe for making accepted quality hydrocarbon products in a timely manner, wherein NLP techniques is further defined herein to include all techniques other than LP techniques. Recursion, DR, or the like are techniques that introduce non-linearity to an LP, wherein at each successive pass, the coefficients for the linear program matrix are updated with more accurate values reflecting a change in a dependent variable over a limited change in an independent variable, keeping all other independent variables constant. However, in accordance with the present invention, rather than substituting updated values obtained from the previous pass for each successive pass in the linear program (and continuing the recursion passes until convergence upon a solution), updated values for some process variables are obtained from a non-linear simulator and passed into the linear program.

Preferably, an embodiment of the present invention employs a constrained linear component integrated with a constrained non-linear model component, for example and LP integrated with an NLP. More preferably, the present invention employs a linear model component known as PIMS-LP integrated with a constrained, non-linear model component. Most preferably, PIMS-LP further comprises a CPLEX® linear solver having a matrix integrated with one or more non-linear process simulators, with the non-linear simulator interfacing directly through run-time memory (in contrast to regenerating data or accessing stored data), which allows direct access for input to and output from the CPLEX® matrix.

PIMS-LP is designed around a spreadsheet such as an EXCEL spreadsheet or a database such as an ACCESS database (that is, the matrix of PIMS-LP is generated from the data contained in one or more EXCEL spreadsheets and/or ACCESS databases) and further comprises an application programming interface known as PIMS-SI (Simulation Interface), which allows other model components (e.g., non-linear simulators) to interface with the PIMS-LP, for example to exchange or update information such as process variables or coefficients in an underlying spreadsheet. Alternatively, model components such as non-linear simulators may interface with PIMS-LP via EXCEL's Visual Basic for Applications (VBA).

In an embodiment of the invention, steam cracker sub-model 310 is a PIMS-LP that is operatively coupled to a SPYRO® simulator 325 through use of an EXCEL workbook interface containing input and output spreadsheets that are accessible to PIMS-LP and SPYRO® via PIMS-SI. Preferably, four spreadsheets are used—two for the input (sheet 1) and output (sheet 2) from PIMS-LP and two for the input (sheet 3) and output (sheet 4) from SPYRO®. For example, an input spreadsheet is for input of information from the PIMS-LP into the SPYRO® simulator such as feed rates; feed properties (components, specific gravity, sulfur, etc.); unit operational parameters (temperatures, pressures, ratios, severity, selectivity, etc.); and general PIMS-LP information (pass number, items out of tolerance, objective function, solution status, case number, etc.). An output spreadsheet is for output of information from the SPYRO® simulator into the PIMS-LP such as vectors for changing the value of coefficients in the linear program matrix (e.g., yield base vector, feed property vectors, unit operational parameters vectors, etc.) and PIMS-LP information such as recursion rows to pass quality information, capacity rows, etc. In order to minimize processing time for convergence, preferably these input and output spreadsheets are held open during recursion by the linear program, rather than being opened, saved, and closed during each recursion pass. More preferably, the spreadsheets are held open by using a switch available in PIMS-LP versions 12.31 and higher. Processing time may be further minimized by imposing rules upon the EXCEL interface between the linear program (e.g., PIMS-LP) and the non-linear simulator (e.g., SPYRO®) such as running multiple cases with one call to the non-linear simulator; only running the non-linear simulator after a given number of recursion passes by the linear program; only running the non-linear simulator if the linear program is feasible; not running the non-linear simulator where the variance of components between each pass is within a given tolerance; and not recalculating new coefficients for components having a variance within a given tolerance. Such rules may be applied as methods using EXCEL VBA via object oriented programming techniques and event handling protocols. The following is an example of pseudo-code showing how an event in EXCEL can trigger a method that is used to control the speed of convergence:

Private Sub Worksheet_Calculate ()
Dim sh As Excel.Worksheet
Dim sh1 As Excel.Worksheet
Set sh = Excel.Worksheets(“Input”)
Set sh1 = Excel.Worksheets(“SpyroIn”)
Excel.Worksheets(“SpyroIn”).Select

If sh1.Range(“J1”) = 1 Then

Worksheets(“Input”).Select
CS = sh.Range(“ConvergeSwitch”).Value
If sh.Range(“PASS”).Value = 1 Then

sh.Range(sh.Cells(3, 13), sh.Cells(62, 113)).Clear

End If
'Log information from this pass
sh.Range(“B3:B61”).Copy
sh.Cells(3, sh.Range(“PASS”).Value + 12).
PasteSpecial xlValues
sh.Cells(62, sh.Range(“PASS”).Value + 12) = CS
'Save input if we call Spyro

If CS = 0 Then Call SaveInput
End If

End Sub

In an embodiment of the invention, refinery site model 305 is a PIMS-LP that is operatively coupled to a DEMEX simulator 315 through use of the PIMS-SI interface having an EXCEL workbook containing input and output spreadsheets. The input spreadsheet is for input of information from the PIMS-LP into the DEMEX simulator such as the following examples:

DEMEX NON-LINEAR SIMULATOR INPUT VARIABLES

| | | |
|---|---|---|
| Tag | Value | *** |

PIMS System Variables

| | | |
|---|---|---|
| PASS | 5 | Recursion Pass Number |
| NTOL | 747 | Items out of Tolerance |
| OBJFN | 2,522.528 | Objective Function |
| STATUS | 0 | Solution Status |
| CASE | 38 | Current Case Number |

Operating Parameter Shift Variables

| | | |
|---|---|---|
| SDMXUP2 | 0 | Ext Temp Up, ° F. |
| SDMXDN2 | 0 | Ext Temp Down, ° F. |
| SDMXUP1 | 0 | Solv/Feed Ratio Up |
| SDMXDN1 | 0 | Solv/Feed Ratio Down |
| SDMXUP3 | 0 | Vacuum Tower Pressure |
| SDMXDN3 | 0 | Vacuum Tower Pressure |
| SDMXUP4 | 0 | Vacuum Tower Temperature |
| SDMXDN4 | 0 | Vacuum Tower Temperature |
| SDMXUP5 | 0 | Resin Settler Pressure |
| SDMXDN5 | 0 | Resin Settler Pressure |
| SDMXUP6 | 0 | Resin Settler Temperature |
| SDMXDN6 | 0 | Resin Settler Temperature |
| SDMXUP7 | 0 | Solvent Critical Temperature |
| SDMXDN7 | 0 | Solvent Critical Temperature |
| SDMXUP8 | 0 | Solvent Molecular Weight |
| SDMXDN8 | 0 | Solvent Molecular Weight |

Feed Quality Shift Variables

| | | |
|---|---|---|
| SDMXVTB | 17000 | VTB Rate, KB/D |
| ISPGVTB | 1.018 | VTB Specific Gravity |
| IWSUVTB | 37 | VTB Sulfur, wt % |
| IMVAVTB | 147.3 | VTB Vanadium, ppm wt |
| IMNIVTB | 464 | VTB Nickel, ppm wt |
| IWCCVTB | 204 | VTB Concarbon, wt % |
| INTRVTB | 4,837 | VTB Total Nitrogen |
| IANLVTB | 198 | VTB Aniline Point, ° F. |
| IVBIVTB | 4.9 | VTB Viscosity Blending Index |

The output spreadsheet is for output of information from the SPYRO simulator into the DEMEX such as the following examples:

DEMEX NON-LINEAR SIMULATOR OUTPUT VARIABLES

| | | | |
|---|---|---|---|
| Row | Column | Value | *** |

Product Yields

| | | | |
|---|---|---|---|
| VBALDMT | SDMXBDF | −03946 | Demetallized Oil |
| VBALRE1 | SDMXBDF | −0.1728 | Resin |
| VBALAS1 | SDMXBDF | −04270 | Asphaltenes |
| VBALDMT | SDMXUP1 | 00447 | Demetallized Oil |
| VBALRE1 | SDMXUP1 | 02839 | Resin |
| VBALAS1 | SDMXUP1 | −03013 | Asphaltenes |
| VBALDMT | SDMXNTR | 00097 | Demetallized Oil |
| VBALRE1 | SDMXNTR | −00037 | Resin |
| VBALAS1 | SDMXNTR | −00046 | Asphaltenes |

Product Qualities

| | | | |
|---|---|---|---|
| RBALDMT | SDMXBDF | −03946 | RECURSION BALANCE |
| RBALRE1 | SDMXBDF | −01728 | RECURSION BALANCE |
| RBALAS1 | SDMXBDF | −04270 | RECURSION BALANCE |
| RSPGDMT | SDMXBDF | −03807 | Specific Gravity Shift DMO |
| RSPGRE1 | SDMXBDF | −01733 | Specific Gravity Shift Resin |
| RSPGAS1 | SDMXBDF | −0.4644 | Specific Gravity |
| | | | Shift Asphaltenes |
| RMVAAS1 | SDMXNTR | 00000 | Vanadium Shift Asphaltenes |
| RANLDMT | SDMXNTR | 00000 | Aniline Point Shift DMO |
| RANLRE1 | SDMXNTR | 00000 | Aniline Point Shift Resin |

Operating Parameter Shift Vectors

| | | | |
|---|---|---|---|
| RSFRdmx | SDMXONE | −461 | Solvent to Feed |
| | | | Ratio Calculation |
| RExTdmx | SDMXONE | −2484 | Extractor Temp Calculation |
| RVTPdmx | SDMXONE | −1365 | Vac Twr Pres Calculation |
| RVTTdmx | SDMXONE | −7190 | Vac Twr Temp Calculation |
| RSFRdmx | SDMXUP1 | −048 | Solvent to Feed |
| | | | Ratio Calculation |
| LSFRdn1 | SDMXUP1 | −048 | Solvent to Feed |
| | | | Ratio Up Shift |
| GSFRup1 | SDMXUP1 | −048 | Solvent to Feed |
| | | | Ratio Up Limit |
| RSMWdmx | SDMXDNB | 008 | Solvent MW Calculation |
| GSMWup8 | SDMXDNB | 008 | Solvent MW Down Shift |
| LSMWdn8 | SDMXDNB | 008 | Solvent MW Down Limit |

Feed Quality Parameter Shift Vectors

| | | | |
|---|---|---|---|
| EFDRD01 | SDMXONE | 17000 | Feed Rate Delta Shift |
| EFDRD01 | SDMXD01 | 1.495 | Feed Rate Delta Shift |
| RAPGdmx | SDMXONE | −745 | Feed API Gravity Calculation |
| EAPGD01 | SDMXONE | 745 | Feed API Gravity Delta Shift |
| EAPGD02 | SDMXD02 | 086 | Feed API Gravity Delta Shift |
| EWCCDMX | SDMXWCC | 159 | Feed Concarbon Delta Shift |
| ENTRDMX | SDMXBDF | 4.837 | Feed Nitrogen Delta Shift |
| ENTRDMX | SDMXNTR | 4903 | Feed Nitrogen Delta Shift |

Techniques such as those described previously may be used to minimize processing time for convergence.

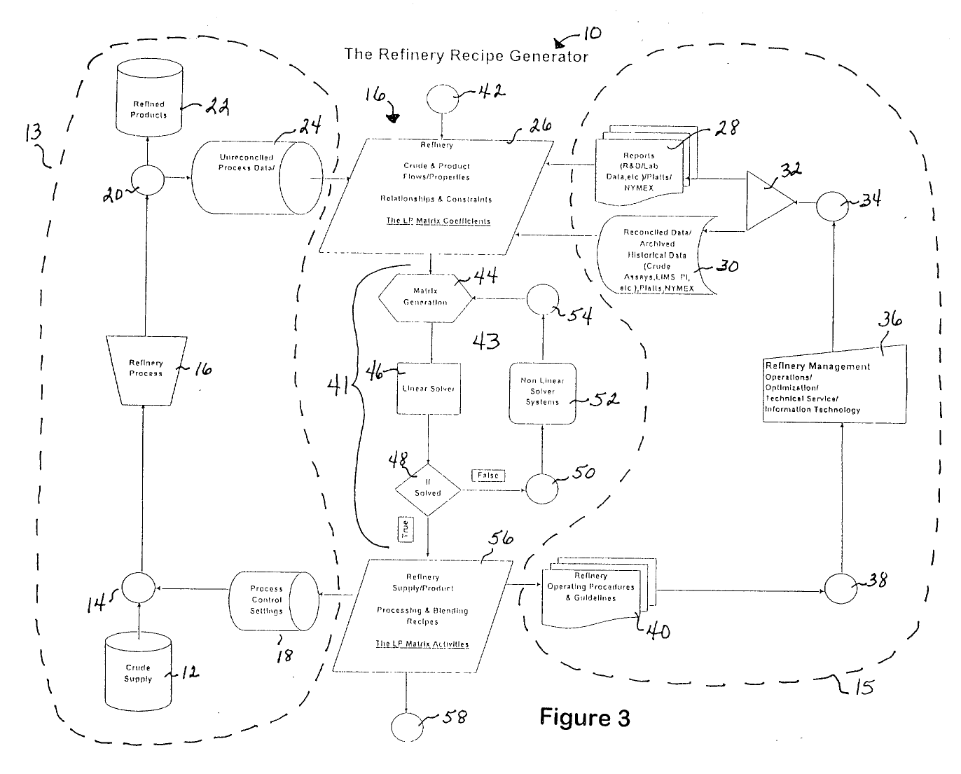

FIG. 3 is an embodiment of the present invention referred to as a refinery recipe generator 10 wherein a real world process (represented within dashed line section 13) having real world operational, experimental, and managerial data (represented within dashed line section 15) is modeled using integrated linear and non-linear model components for generating hydrocarbon product specifications (as represented by modeling section 16 located between sections 13 and 15), and in particular for generating optimized recipes for blended products such as gasoline, diesel, #6 oil, and asphalt from a petroleum refinery. The recipe generator 10 is accessible via connectors 42 and 58. While the embodiment of FIG. 3 is directed to the refining of crude oil, the methodology therein is applicable to any hydrocarbon or other chemical production facility.

Section 13 of FIG. 3 represents the physical hydrocarbon and/or chemical process or plant to be modeled comprising input or feed to the process, the hydrocarbon and/or chemical synthesis, and the output or products from the process. More specifically in the context of a petroleum refinery, a crude supply 12 is refined in refinery process 16 to produce refined products 22. The crude supply 12 may comprise a variety of feedstocks such as those available in on-site inventory, other feedstocks that are available through the market (e.g., tankers, pipelines, etc.), and combinations thereof. The refinery process 16 may be any suitable combination of refining processes, units, and blending facilities to produce the desired refined products. The refinery process 16 comprises a plurality of process controllers such as temperature controllers, pressure controllers, composition controllers, flow rate controllers, level controllers, valve controllers, equipment controllers, and the like. Such controllers are preferably computer controlled via corresponding process control settings 18, sometimes referred to by industry as set points. Process control settings are typically stored in computer datastores (e.g., databases and the like), which may be physically separated and linked via a computer network and are accessible to the modeling section via connector 14, which, as with the other connectors disclosed herein, may be manual and/or automatic access and may be for data input and/or output. The refinery process 16 comprises a plurality of process sensors, often corresponding to a like controller, such as temperature sensors, pressure sensors, composition sensors, flow rate sensors, level sensors, valve sensors, equipment sensors, and the like. These sensors generate non-reconciled process data and constraints 24, which is typically stored in computer datastores as discussed previously and accessible to the modeling section 16 via connector 20. Non-reconciled process data refers to the raw process data that is taken directly from the sensors and that has not undergone any modification or reconciliation such as a mass and/or energy balance reconciliation. Non-reconciled process data 24 provides a snapshot of the real world operating conditions of the process.

Operational, experimental, and managerial data section 15 of FIG. 3 represents real world constraints on the physical hydrocarbon and/or chemical process represented by section 13, and further comprises refinery operating procedures 40, refinery management input 36, current supply information 28, and historical supply information 30, each of which is accessible to the modeling section 16 via connectors 34 and 38. Refinery management input 36 encompasses input, typically manual rather than automated, of several factors such as operational goals, optimization goals, technical service, and information technology. Essentially, this is where the management decisions and business objectives for current operation of the refinery get factored into the relationships for modeling the process. Refinery operating procedures 40, while similar to refinery management decisions, are established guidelines for operating the refinery such as design, safety, environmental, and other similar constraints. The current external information 28 may include technical data such as research and development information and laboratory test results for products and feedstocks (e.g., crude assays) as well as financial information such as commodity/product pricing (e.g., New York Mercantile Exchange data) and energy costs (e.g., Platts Global Energy data). The historical external information 30 may include the same or similar data as current external information 28 (for example, reconciled process data, historical product pricing, seasonal cost and pricing trends, energy costs, crude assays, etc.), but covering a historical period such that tendencies (trend data) may be included in the modeling. The current external information 28 and historical external information 30 are referred to as external as they are typically obtained from or derived by sources external to the actual operating process (data from which is available as non-reconciled process data 24) and preferably are stored and accessible from a data storage unit 32.

As is shown in FIG. 3 and explained in more detail herein, modeling section 16 is operatively coupled via connectors 14, 20, 34, and 38 in a feedback loop relationship with the physical hydrocarbon and/or chemical process represented by section 13 and the operational, experimental, and managerial data by section 15. Modeling section 16 of FIG. 3 further comprises a model preparation step 26, a solver array 43, and a model output step 56. In model preparation step 26, the process simulation model is developed or programmed, typically involving one or more process engineers and/or computer programmers. As discussed previously, the model may be of any suitable category such as statistical and/or first principle, and may further comprises any suitable number of model components (preferably corresponding to units within the process), including commercially available components such as those described previously. The model is typically based on well known mathematical and engineering relationships and constraints such as mass and energy balances, chemical reaction kinetics, and the like, as well as other real world operating constraints as discussed previously. In preparing the model, real world operating data and constraints are imported from the process, including refinery operating procedures 40, refinery management input 36, current external information 28, and historical external information 30, and non-reconciled process data 24.

The mathematical model prepared in model preparation step 26 is solved by a solver array 43 comprising linear program 41 (corresponding to linear program 305 in FIG. 2) integrated with one or more non-linear simulators 52 (corresponding to simulators 315, 320, and 325 in FIG. 2), as discussed previously. The linear program 41 preferably employs recursion or distributed recursion for convergence upon a solution, and more preferably is a PIMS-LP. The linear program 41 further comprises by matrix generator 44, a linear solver 46, and a comparator or evaluation step 48. Matrix generator 44 is a computer application or program for generating a matrix from a set of mathematical formulas and equations and establishes a matrix suitable for being solved by the linear solver 46, preferably the CPLEX® linear solver. Preferably, the matrix generator 44 is a component of the PIMS-LP and conforms to the input requirements or API of the CPLEX® linear solver. The matrix corresponds to the linear program standard form as described previously, and comprises dependent and independent process variables as well as coefficients or “adjustment factors” for each of these variables is established by matrix generator 44. A simplified example of a two-by-two matrix is:

$$( \begin{matrix}Gasoline Yield ( x , y ) \\ Diesel Yield ( x , y )\end{matrix} ) = ( \begin{matrix}a & c \\ b & d\end{matrix} ) * ( \begin{matrix}X \\ Y\end{matrix} )$$

where the following is the dot product of the coefficients with the independent variables

Gasoline Yield=aX+bY

Diesel Yield=cX+dY

and where X and Y represent process variables, and a, b, c, and d are coefficients for adjusting the values of the corresponding variables. In other words, the coefficients a, b, c, and d represent the interaction for the relationships, with each relationship having one or more independent variable (X and Y) and one or more dependent variables (Gasoline Yield and Diesel Yield). In physics, a vector represents quantities that have both magnitude and direction, i.e. velocity. For example, it is not enough to define the velocity of an object by stating it is traveling at a speed of 5 miles per hour. The direction of the object is also required, i.e., the object is traveling 5 mi/hr to the Northeast. However, Northeast is somewhat vague, whereas the object is heading 4 mi/hr North and 3 mi/hr East at the same time is more descriptive, whereas its speed is still 5 mi/hr. Analogously the simplified matrix example above breaks the yield of the gasoline into process components. For example, in processing gas oil through the FCC unit, if the temperature (X) of the reactor is increased, the yield of gasoline (light) increases (“a” would have a positive magnitude) and if the catalyst to gasoil ratio (Y) increases then the gasoline also increases (“b” would also have a positive magnitude), where the sum product of all the influences yields the total amount of gasoline. Similarly, the diesel yield through the FCC increases with an increase in temperature (“c” would have also a positive magnitude) but decreases on increasing the catalyst to gasoil ratio (“d” would have a negative magnitude). Therefore, hydrocarbon streams can be represented as vectors where the sum products of their influential processing components describe their yields. Preferably, the columns of the matrix comprise independent process variables and the rows of the matrix comprise dependent process variables. A coefficient exists for each variable, and where there is no relationship between the independent and dependent variable, the coefficient is zero.

In the model preparation step 26, initial values of for the variables and coefficients in the matrix are provided (sometimes referred to as initial guesses), preferably based on historical data, previous simulations, engineering estimates, and the like. These values are passed to a linear solver 46 to produce calculated values for the variables and coefficients (first pass values corresponding to the first recursion pass, second pass variables corresponding to the second recursion pass, and the like). Any suitable linear solver may be employed, for example CLPEX® or XPRESS® commercially available through Aspen Technology, Inc., Frontline System, Inc., ILOG, etc. As the guesses for the variables are virtually certain to be incorrect, numerous recursion or distributed recursion passes will be needed in order to converge upon a solution. The calculated variables for a given pass are compared against a set of constraints or tolerances to determine if the linear program has converged upon a solution. In determining whether the linear program has converged, the current pass values compared to the immediately preceding pass values to determine the differences. If the difference is greater than the tolerance, then the evaluation is false and the linear program has not converged upon an acceptable solution. Thus, the values for the variables must be adjusted by changing the coefficients described previously. For each variable, the differences produced during successive passes are examined to determine whether the linear solver is accurately representing the behavior of the variable. Certain variables are coded in the model to be updated by the LP while other variables are coded in the model to be updated by the NLP, and such coding may be updated to reflect results over time, either modeling results, real world process results, or both. For variables displaying linear behavior (and coded as such within the LP), the coefficients for such variables are not changed in the PIMS-LP. That is, the independent variables are changed in a stepwise fashion to maximize the objective function using typical EP methods. Recursion ceases when the difference between independent variables (also referred to as the activity) in the last recursion pass is the same as the current pass within a desired tolerance. In such case, the coefficient becomes a constant value corresponding to the slope of the linear equation with respect to each individual independent variable holding all others the same. In addition, for variables identified as displaying non-linear behavior (and coded as such, preferably via the input/output file to the NLP), a non-linear solver system 52 can be added externally to the PIMS-LP framework to adjust the coefficients for such variables. The non-linear solver system 52 can comprise of more than one non-linear solver, and preferred non-linear solver systems or simulators include those described previously and shown in FIG. 2. Following a given pass by the linear program, the non-linear solver system 52 accesses the variables and corresponding coefficients showing non-linear behavior via connector 50. The output data from the PIMS-LP model is placed as input to the non-linear model. The non-linear model calculates new linear coefficients (slopes) for each independent variable within a predefined step or increment size holding everything else constant. The coefficients residing in the matrix after a given pass are accessed and adjusted via connector 54, thereby providing updated values for the coefficients for use by the linear program in the next recursion pass. Using the updated coefficients (for both the linear and non-linear variables), the results from linear solver 46 are examined by evaluation step 48 during each recursive pass, and when all variables are within tolerance, the linear program has converged upon a solution, which is passed to model output step 56.

Model output step 56 preferably comprises an optimized solution for operating the refinery and/or producing products to achieve the optimized target, preferably maximum profitability, for the given operating conditions, feedstocks, constraints, and the like. Preferably, model output step 56 comprises product recipes or blending formulations for products such as hydrogen, fuel gas, liquefied petroleum gases (LPG), propane, propylene, butane, butylenes, pentane, gasoline, reformulated gasoline, kerosene, aviation fuel, high sulfur diesel, low sulfur diesel, high sulfur gas oil, low sulfur gas oil, #6 oil, and asphalt. The model output preferably further comprises data, information, updates, and the like for operation and management of the hydrocarbon and/or chemical process to achieve the desired optimization. For example, the model output preferably comprises updated process control settings 18 that are fed back to the hydrocarbon and/or chemical process represented by section 13, either manually or preferably automatically, to control and operate the process to achieve the desired optimization. The model output preferably further comprises feedstock specifications and logistics as well as updates to refinery operating procedures and guidelines for achieving optimized operations.

### EXAMPLE

The following is an example of a small portion of a matrix for the DEMEX unit described previously. An extractor column is provided for receiving the bottom (heavy) portion from a vacuum tower comprising demetalized oil (DMO), resin, and asphalt. In addition to this, propane and butane are provided as solvent for the extraction. From the top of the extraction column DMO and resin are collected and forwarded to a flash drum to produce separate products of DMO and resin. Asphalt is collected from the bottom of the extractor column. For this example, the dependent variables represent product yields from the extractor column and the independent variables represent the temperature of the extractor column, and therefore the addition of the activities for the feed and products must equal zero because of a mass balance constraint. More specifically, relationships to describe the yield from the extractor column are therefore:

Yield(DMO)=a_{DMO}*Tₑₓₜ

Yield(Resin)=a_{Resin}*Tₑₓₜ

Yield(Asphalt)=a_{Asphalt}*Tₑₓₜ

Temperature is an independent variable and would therefore be a column element in the matrix, and yield, a dependent variable, would be a row element. The relationship of the activity of temperature needs to equal zero for the conservation of mass.

a_{DMO}+a_{Resin}+a_{Asphalt}=0

Also, a_{DMO}+a_{Resin}=−a_{Asphalt}

While preferred embodiments of this invention have been shown and described, modifications thereof can be made by one skilled in the art without departing from the spirit or teaching of this invention. Accordingly, the embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

What we claim as our invention is:

1. A method for operating a hydrocarbon or chemical production facility, comprising:
mathematically modeling the facility;
optimizing the mathematic model with a combination of linear and non-linear solvers; and
generating one or more product recipes or operating setpoints based upon the optimized solution.

2. The method of claim 1 wherein the mathematic model further comprises a plurality of process equations having process variables and corresponding coefficients.

3. The method of claim 2 wherein the process variables and corresponding coefficients are used to create a matrix in a linear program.

4. The method of claim 3 wherein the linear program is executed via recursion.

5. The method of claim 3 wherein the linear program is executed via distributed recursion.

6. The method of claim 4 wherein upon successive recursion passes, updated values for a portion of the process variables and corresponding coefficients are calculated by the linear solver.

7. The method of claim 6 wherein upon successive recursion passes, updated values for a portion of the process variables and corresponding coefficients are calculated by a non-linear solver.

8. The method of claim 7 wherein the updated values the process variables and corresponding coefficients are substituted into the matrix.

9. The method of claim 8 wherein recursion continues until the updated values for the process variables and corresponding coefficients calculated by the linear program for the current recursion pass are within a given tolerance when compared to their corresponding values for the immediately preceding recursion pass.

10. The method of claim 9 wherein the linear program is PIMS-LP.

11. The method of claim 10 wherein the linear solver is CPLEX or XPRESS.

12. The method of claim 11 wherein the process variables and corresponding coefficients of the matrix are stored in one or more spreadsheets or databases.

13. The method of claim 12 wherein non-linear solver accesses the spreadsheets via PIMS-SI.

14. The method of claim 12 wherein the non-linear solver accesses the spreadsheets via Visual Basic for Applications (VBA).

15. The method of claim 13 wherein the production facility is a petroleum refinery.

16. The method of claim 15 wherein a portion of the petroleum refinery selected from the group consisting of crude distillation, hydrocarbon distillation, reforming, aromatics extraction, toluene disproportionation, solvent deasphalting, fluidized catalyst cracking (FCC), gas oil hydrotreating, distillate hydrotreating, isomerization, sulfuric acid alkylation, and cogeneration is simulated by the non-linear solver.

17. The method of claim 16 wherein the generated recipes are for one or more products selected from the group consisting of hydrogen, fuel gas, LPG, propane, propylene, butane, butylenes, pentane, gasoline, reformulated gasoline, kerosene, aviation fuel, high sulfur diesel, low sulfur diesel, high sulfur gas oil, low sulfur gas oil, #6 oil, and asphalt.

18. The method of claim 17 wherein the process variables include composition of the crude feedstock to the refinery.

19. The method of claim 18 further comprising selecting among one or more crude feedstocks to the refinery based upon the optimized solution.

20. A computerized system for operating a hydrocarbon or chemical production facility, comprising a computer hosting a mathematic model of the facility, wherein the computer optimizes the mathematic model by executing a combination of linear and non-linear solvers and generates one or more product recipes based upon the optimized solution.

21. The system of claim 20 wherein the computer interfaces with process controllers within the production facility to provide set points based upon the optimized solution.

22. The system of claim 21 wherein the computer controls a product blending system within a petroleum refinery to produce one or more products selected from the group consisting of hydrogen, fuel gas, LPG, propane, propylene, butane, butylenes, pentane, gasoline, reformulated gasoline, kerosene, aviation fuel, high sulfur diesel, low sulfur diesel, high sulfur gas oil, low sulfur gas oil, #6 oil, and asphalt.
